(19) United States
(12) Patent Application Publication
(10) Pub. No.: US 2022/0351224 A1
(43) Pub. Date: Nov. 3, 2022

(54) INFORMATION PROCESSING DEVICE, METHOD, AND PROGRAM

(71) Applicant: TOYOTA JIDOSHA KABUSHIKI KAISHA, Toyota-shi Aichi-ken (JP)

(72) Inventors: Tadahiro KASHIWAI, Nagoya-shi (JP); Toyokazu NAKASHIMA, Nagoya-shi (JP); Hideo HASEGAWA, Nagoya-shi (JP); Kazuya IWATA, Nagoya-shi (JP); Shinichiro IIDA, Toyota-shi (JP); Kiyonori YOSHIDA, Toyota-shi (JP); Yota SAKURAI, Nagoya-shi (JP)

(73) Assignee: TOYOTA JIDOSHA KABUSHIKI KAISHA, Toyota-shi Aichi-ken (JP)

(21) Appl. No.: 17/728,027

(22) Filed: Apr. 25, 2022

(30) Foreign Application Priority Data
Apr. 30, 2021 (JP) 2021-078070

(51) Int. Cl. G06Q 30/02; B60W 40/09

(52) U.S. Cl. CPC G06Q 30/0207; B60W 40/09; B60W 2420/42; B60W 2552/53

(57) ABSTRACT

A control unit of an information processing device outputs proposal information for proposing to a user of a vehicle that an incentive is given when the user passes, in the vehicle, a point where traffic frequency becomes less than a predetermined threshold value and stops at a predetermined facility, and determines that the incentive is given to the user when determination is made that the user has passed the point in the vehicle and has stopped at the predetermined facility based on movement information of the user.

### CROSS-REFERENCE TO RELATED APPLICATION

This application claims priority to Japanese Patent Application No. 2021-078070 filed on Apr. 30, 2021, incorporated herein by reference in its entirety.

### BACKGROUND

### 1. Technical Field

The present disclosure relates to an information processing device, method, and a program.

### 2. Description of Related Art

Conventionally, a technique for alleviating traffic congestion has been known. For example, Japanese Unexamined Patent Application Publication No. 2019-160055 (JP 2019-160055 A) discloses a technique for controlling traffic flow for alleviating traffic congestion by encouraging a user to shift a departure time from a destination on a return trip.

### SUMMARY

There was room for improvement in a technique for alleviating traffic congestion.

The purpose of the present disclosure made in view of such circumstances is to improve the technique for alleviating the traffic congestion.

An information processing device according to one embodiment of the present disclosure includes a control unit. The control unit outputs proposal information for proposing to a user of a vehicle that an incentive is given when the user passes, in the vehicle, a point where traffic frequency becomes less than a predetermined threshold value and stops at a predetermined facility, and determines that the incentive is given to the user when determination is made that the user has passed the point in the vehicle and has stopped at the predetermined facility based on movement information of the user.

A method according to the one embodiment of the present disclosure is a method executed by an information processing device and includes outputting proposal information for proposing to a user of a vehicle that an incentive is given when the user passes, in the vehicle, a point where traffic frequency becomes less than a predetermined threshold value and stops at a predetermined facility, and determining that the incentive is given to the user when determination is made that the user has passed the point in the vehicle and has stopped at the predetermined facility based on movement information of the user.

A program according to the one embodiment of the present disclosure causes a computer to execute outputting proposal information for proposing to a user of a vehicle that an incentive is given when the user passes, in the vehicle, a point where traffic frequency becomes less than a predetermined threshold value and stops at a predetermined facility, and determining that the incentive is given to the user when determination is made that the user has passed the point in the vehicle and has stopped at the predetermined facility based on movement information of the user.

According to the one embodiment of the present disclosure, it is possible to improve the technique for alleviating traffic congestion.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a schematic configuration of a system according to one embodiment of the present disclosure;

FIG. 2 is a block diagram showing a schematic configuration of an information processing device according to the one embodiment of the present disclosure;

FIG. 3 is a block diagram showing a schematic configuration of a terminal device according to the one embodiment of the present disclosure;

FIG. 4 is a flowchart showing a first operation of the information processing device according to the one embodiment of the present disclosure;

FIG. 5 is a flowchart showing a second operation of the information processing device according to the one embodiment of the present disclosure; and

FIG. 6 is a diagram showing an example of giving an incentive according to the one embodiment of the present disclosure.

### DETAILED DESCRIPTION OF EMBODIMENTS

Hereinafter, an embodiment of the present disclosure will be described.

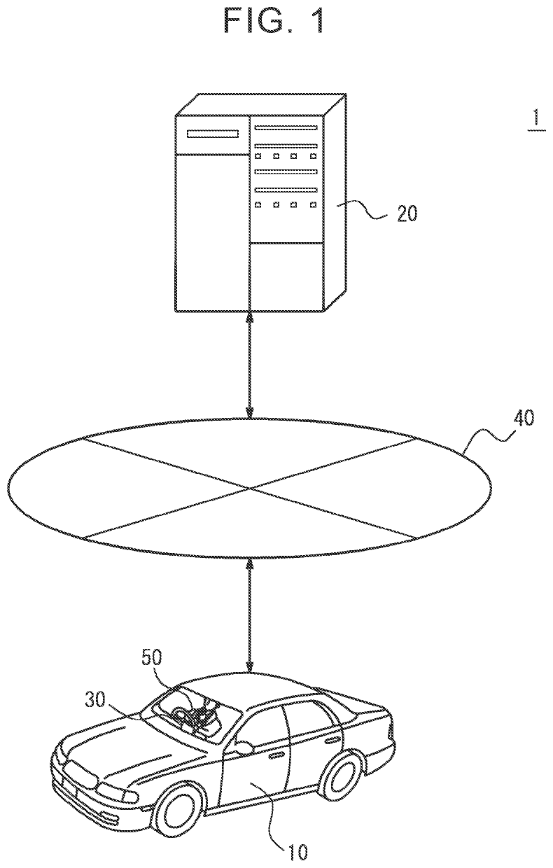

The outline of a system 1 according to an embodiment of the present disclosure will be described with reference to FIG. 1.

The system 1 includes a vehicle 10, an information processing device 20, and a terminal device 30. The vehicle 10, the information processing device 20, and the terminal device 30 are connected to a network 40 so as to be able to communicate with the network 40.

The vehicle 10 is, for example, an automobile, but is not limited to this, and may be any vehicle. Examples of the automobiles include gasoline-powered vehicles, battery electric vehicles (BEVs), hybrid electric vehicles (HEVs), plug-in hybrid electric vehicles (PHEVs), fuel cell electric vehicles (FCEVs), or the like, but are not limited to these. The vehicle 10 may be driven by a driver, or the driving may be automated at a desired level. The level of automation is, for example, one of level 1 to level 5 classified by the Society of Automotive Engineers (SAE). The vehicle 10 may be a vehicle dedicated to “Mobility-as-a-Service (MaaS)”.

The information processing device 20 is, for example, a computer such as a server belonging to a cloud computing system or other computing systems.

The terminal device 30 is connected to the vehicle 10 as an external device or is held by a user 50. The terminal device 30 is, for example, a mobile device such as a mobile phone, a smartphone, or a tablet.

The network 40 includes the Internet, at least one wide area network (WAN), at least one metropolitan area network (MAN), or any combination thereof. The network 40 may include at least one wireless network, at least one optical network, or any combination thereof. The wireless network is, for example, an ad hoc network, a cellular network, a wireless local area network (LAN), a satellite communication network, or a terrestrial microwave network.

The outline of the present embodiment will be described with reference to FIG. 1.

A control unit 21 of the information processing device 20 outputs proposal information for proposing to the user 50 of the vehicle 10 that an incentive is given when the user 50 passes, in the vehicle 10, a point P where traffic frequency becomes less than a predetermined threshold value and stops at a predetermined facility. Then, the control unit 21 of the information processing device 20 determines that an incentive is given to the user 50 when the control unit 21 determines that the user 50 passes the point P in the vehicle 10 and stops at the predetermined facility based on movement information of the user 50.

As described above, according to the present embodiment, the user 50 can obtain an incentive by stopping at a predetermined facility using, for example, a back road or a narrow street where traffic frequency is low. For this reason, it is possible to suppress the user 50 from stopping at a predetermined facility using, for example, a main road where traffic frequency is high. Therefore, it is possible to improve the technique for alleviating the traffic congestion.

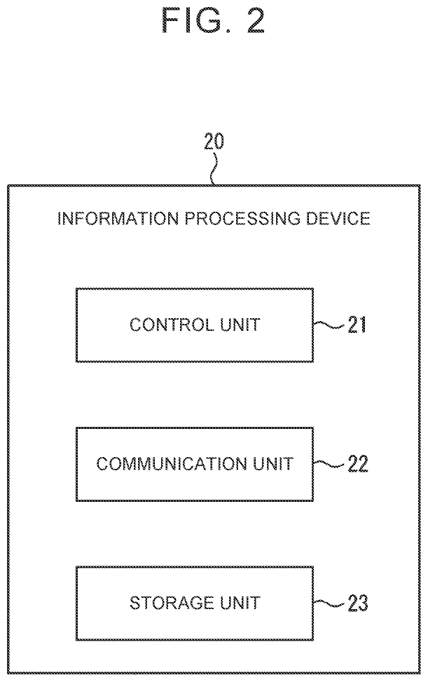

The configuration of the information processing device 20 according to the present embodiment will be described with reference to FIG. 2.

The information processing device 20 includes the control unit 21, a communication unit 22, and a storage unit 23.

The control unit 21 includes at least one processor, at least one programmable circuit, at least one dedicated circuit, or any combination thereof. The processor is a general-purpose processor such as a central processing unit (CPU) or a graphics processing unit (GPU), or a dedicated processor specialized for a specific process. The programmable circuit is, for example, a field-programmable gate array (FPGA). The dedicated circuit is, for example, an application specific integrated circuit (ASIC). The control unit 21 performs processes related to the operation of the information processing device 20 while controlling various units of the information processing device 20.

The communication unit 22 includes at least one communication interface. The communication interface supports, for example, a mobile communication standard, a wired LAN standard, or a wireless LAN standard, but the supported standards are not limited to these, and the communication interface may support any communication standard. The communication unit 22 receives the data used for the operation of the information processing device 20, and transmits the data acquired through the operation of the information processing device 20.

The storage unit 23 includes at least one semiconductor memory, at least one magnetic memory, at least one optical memory, or any combination thereof. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 23 functions as, for example, a main storage device, an auxiliary storage device, or a cache memory. The storage unit 23 stores data used for the operation of the information processing device 20 and data acquired through the operation of the information processing device 20. In the present embodiment, the data used for the operation of the information processing device 20 includes a system program, an application program, a database, map information, and the like.

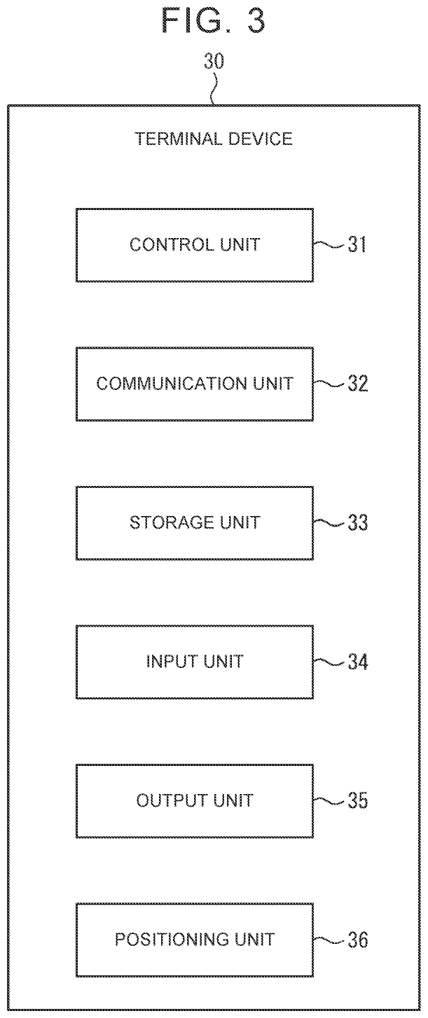

The configuration of the terminal device 30 according to the present embodiment will be described with reference to FIG. 3.

The terminal device 30 includes a control unit 31, a communication unit 32, a storage unit 33, an input unit 34, an output unit 35, and a positioning unit 36.

The control unit 31 includes at least one processor, at least one programmable circuit, at least one dedicated circuit, or any combination thereof. The processor is a general-purpose processor such as a CPU or GPU, or a dedicated processor specialized for a specific process. The programmable circuit is, for example, an FPGA. The dedicated circuit is, for example, an ASIC. The control unit 31 performs processes related to the operation of the terminal device 30 while controlling each unit of the terminal device 30.

The communication unit 32 includes at least one communication interface. The communication interface is, for example, an interface compatible with mobile communication standards such as the long term evolution (LTE), the fourth generation (4G), or the fifth generation (5G), an interface compatible with short-range wireless communication standards such as Bluetooth (registered trademark), or a LAN interface. The communication unit 32 receives the data used for the operation of the terminal device 30, and transmits the data acquired through the operation of the terminal device 30.

The storage unit 33 includes at least one semiconductor memory, at least one magnetic memory, at least one optical memory, or any combination thereof. The semiconductor memory is, for example, a RAM or a ROM. The RAM is, for example, a SRAM or a DRAM. The ROM is, for example, an EEPROM. The storage unit 33 functions as, for example, a main storage device, an auxiliary storage device, or a cache memory. The storage unit 33 stores data used for the operation of the terminal device 30 and data acquired through the operation of the terminal device 30.

The input unit 34 includes at least one input interface. The input interface is, for example, a physical key, a capacitive key, a pointing device, a touch screen integrated with a display, a camera, light detection and ranging or laser imaging detection and ranging (LiDAR), or a microphone. The input unit 34 accepts an operation of inputting data used for the operation of the terminal device 30. The input unit 34 may be connected to the terminal device 30 as an external input device instead of being provided in the terminal device 30. As the connection interface, for example, an interface corresponding to a standard such as universal serial bus (USB), high-definition multimedia interface (HDMI; registered trademark), or Bluetooth (registered trademark) can be used.

The output unit 35 includes at least one output interface. The output interface is, for example, a display or a speaker. The display may be, for example, a liquid crystal display (LCD), an organic electroluminescence (EL) display, or the like. The output unit 35 outputs the data acquired through the operation of the terminal device 30. The output unit 35 may be connected to the terminal device 30 as an external output device instead of being provided in the terminal device 30. As the connection interface, for example, an interface corresponding to a standard such as USB, HDMI (registered trademark), or Bluetooth (registered trademark) can be used.

The positioning unit 36 includes at least one global navigation satellite system (GNSS) receiver. The GNSS is, for example, the global positioning system (GPS), the quasi-zenith satellite system (QZSS), the BeiDou navigation satellite system (BDS), the global navigation satellite system (GLONASS), or Galileo. The positioning unit 36 measures the position of the terminal device 30.

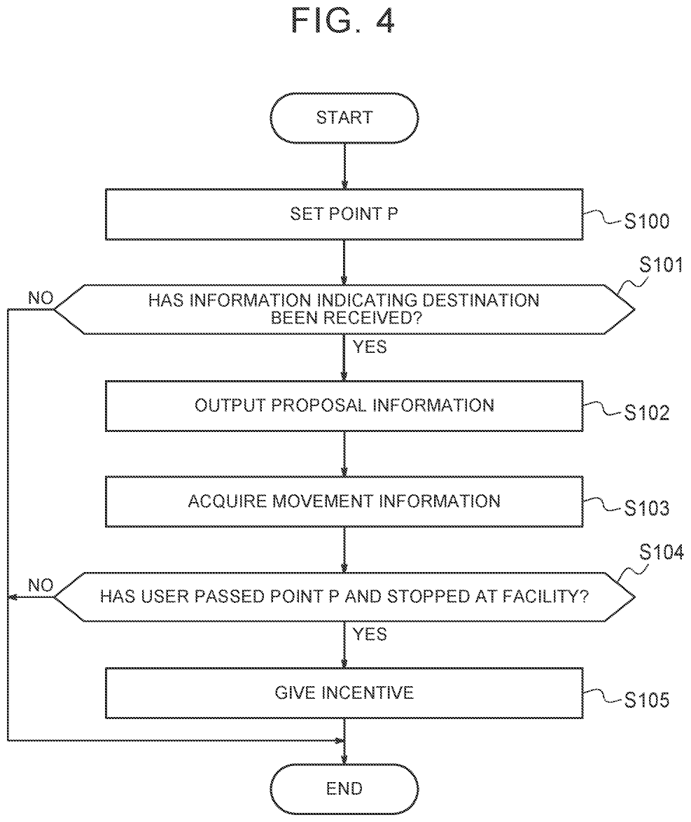

A first operation of the information processing device 20 according to the present embodiment will be described with reference to FIG. 4. The operation corresponds to a method according to one embodiment of the present disclosure.

In the present embodiment, the terminal device 30 is connected to the vehicle 10 as the external device when the user 50 is moving in the vehicle 10, and is held by the user 50 when the user 50 is moving by walking. Therefore, the position of the terminal device 30 corresponds to the positions of the vehicle 10 and the user 50 when the user 50 is moving in the vehicle 10, and the position of the terminal device 30 corresponds to the position of the user 50 when the user 50 is moving by walking.

Step S100: The control unit 21 of the information processing device 20 sets a point P where traffic frequency becomes less than a predetermined threshold value.

Specifically, the control unit 21 of the information processing device 20 specifies a point P where traffic frequency becomes less than a predetermined threshold value (hereinafter abbreviated as a “point P”) based on map information stored in advance in the storage unit 23 and congestion information received from a server or the like that provides the congestion information via the communication unit 22. Then, the control unit 21 of the information processing device 20 adds information indicating the specified point P to the map information. The predetermined threshold value may be set based on, for example, the number of the vehicles 10 passing the point P per unit time. The point P may be set, for example, on a back road or a narrow street.

Step S101: The control unit 21 of the information processing device 20 determines whether information indicating a destination set by the user 50 has been received. When the control unit 21 determines that the information indicating the destination has been received, the process proceeds to step S102. On the other hand, when the control unit 21 determines that the information indicating the destination has not been received, the process ends.

Specifically, the control unit 31 of the terminal device 30 accepts an operation in which the user 50 inputs a destination via the input unit 34 to a map application operated on the terminal device 30. Here, it is assumed that a facility such as a shopping center is located at the destination, and the user 50 desires to stay at this facility. Then, the control unit 31 of the terminal device 30 transmits the information indicating the destination input to the map application operated on the terminal device 30 to the information processing device 20 via the communication unit 32. Then, when the control unit 21 of the information processing device 20 receives the information indicating the destination from the terminal device 30 via the communication unit 22, the control unit 21 determines that the information indicating the destination has been received. A departure place may be automatically detected by the positioning unit 36 of the terminal device 30, or may be manually input by the user 50 in the same manner as the destination. In either case, the control unit 31 of the terminal device 30 transmits information indicating the departure place to the information processing device 20 via the communication unit 32. Then, the control unit 21 of the information processing device 20 receives the information indicating the departure place from the terminal device 30 via the communication unit 22.

Step S102: The control unit 21 of the information processing device 20 outputs proposal information for proposing to the user 50 that an incentive is given when the user 50 passes the point P in the vehicle 10 and stops at a facility located at the destination.

Specifically, the control unit 21 of the information processing device 20 outputs proposal information for proposing to the user 50 that an incentive is given when the user 50 passes the point P in the vehicle 10 and stops at a facility located at the destination. Then, the control unit 21 of the information processing device 20 transmits the generated proposal information to the terminal device 30 via the communication unit 22. Then, the control unit 31 of the terminal device 30 receives the transmitted proposal information from the information processing device 20 via the communication unit 32. Then, the control unit 31 of the terminal device 30 outputs the received proposal information to the user 50 on a screen display or by voice and the like via the output unit 35. For example, the control unit 31 may output the proposal information to the user 50 by displaying the information indicating the point P on the map displayed on the screen of the terminal device 30 as well.

In step S102, the proposal information may include information indicating a movement route including a section from the point P to the facility located at the destination. Specifically, the control unit 21 of the information processing device 20 searches for a movement route from the departure place to the facility located at the destination via the point P based on the map information stored in advance in the storage unit 23. Then, the control unit 21 of the information processing device 20 adds information indicating the searched movement route to the proposal information. In this case, the control unit 31 of the terminal device 30 also outputs the information indicating the movement route received from the information processing device 20 to the user 50 on the screen display or by voice and the like via the output unit 35. One or more movement routes may be shown.

Further, in step S102, the movement route may not include a road having a certain number of lanes or more or an intersection on the road. Specifically, the control unit 21 of the information processing device 20 searches for a movement route that does not include a road having a certain number of lanes or more or an intersection on the road from among movement routes from the departure place to the facility located at the destination via the point P based on the map information stored in advance in the storage unit 23. Then, the control unit 21 of the information processing device 20 adds the information indicating the searched movement route to the proposal information. The road having a certain number of lanes or more may include, for example, a main road having two or more lanes on each side, but is not limited to this.

Step S103: The control unit 21 of the information processing device 20 acquires movement information of the user 50.

Specifically, the positioning unit 36 of the terminal device 30 repeatedly measures the position of the terminal device 30. Then, the control unit 31 of the terminal device 30 transmits information indicating the position of the terminal device 30 to the information processing device 20 via the communication unit 32 every time the positioning unit 36 measures the position of the terminal device 30. Then, the control unit 21 of the information processing device 20 receives the information indicating the position of the terminal device 30 from the terminal device 30 via the communication unit 22. Then, when the control unit 21 of the information processing device 20 determines that the position of the terminal device 30 matches any position in the facility located at the destination, the control unit 21 acquires information indicating the movement route of the terminal device 30 corresponding to the movement information of the user 50 by analyzing transition of the position of the terminal device 30 in the past. The match in the present embodiment does not have to be a mathematically exact match, and may be a match within an allowable range.

In step S103, when the user 50 is moving in the vehicle 10, the control unit 21 of the information processing device 20 may acquire the movement information of the user 50 based on the information indicating the position of the vehicle 10 acquired from a car navigation device mounted on the vehicle 10 via the communication unit 22.

Step S104: The control unit 21 of the information processing device 20 determines whether the user 50 has passed the point P in the vehicle 10 and has stopped at the facility located at the destination based on the movement information of the user 50. When the control unit 21 determines that the user 50 has passed the point P in the vehicle 10 and has stopped at the facility located at the destination, the process proceeds to step S105. On the other hand, when the control unit 21 determines that the user 50 has passed the point P in the vehicle 10 but has not stopped at the facility located at the destination, the process ends.

Specifically, the control unit 21 of the information processing device 20 determines whether the point P is included in the movement route of the terminal device 30 based on the information indicating the movement route of the terminal device 30 corresponding to the movement information of the user 50.

Step S105: The control unit 21 of the information processing device 20 determines that an incentive is given to the user 50.

Specifically, the control unit 21 of the information processing device 20 determines that an incentive that includes providing a point that can be used when the user 50 purchases some products or receives some services in the facility located at the destination is given to the user 50. Then, the control unit 21 of the information processing device 20 transmits information indicating the determination result and identification information of the terminal device 30 to any store terminal installed in the facility located at the destination via the communication unit 22. For example, an incentive may be given to the user 50 via a camera mounted on or connected to the terminal device 30 when the camera reads a one-dimensional code or two-dimensional code, etc. displayed on the screen of the store terminal.

In step S105, the control unit 21 of the information processing device 20 may determine the incentive according to the number of times the user 50 has acted in accordance with the proposal information proposed in the past in the same manner as in step S102. Specifically, the control unit 21 of the information processing device 20 may determine that the more times the user 50 has acted in accordance with the proposal information proposed in the past in the same manner as in step S102, the larger the amount of incentive the user is given.

Further, in step S105, when the control unit 21 of the information processing device 20 determines that the user 50 has acted in accordance with the movement route proposed in step S102, the large amount of incentive is given as compared with a case where the user 50 does not act in accordance with the movement route proposed in step S102.

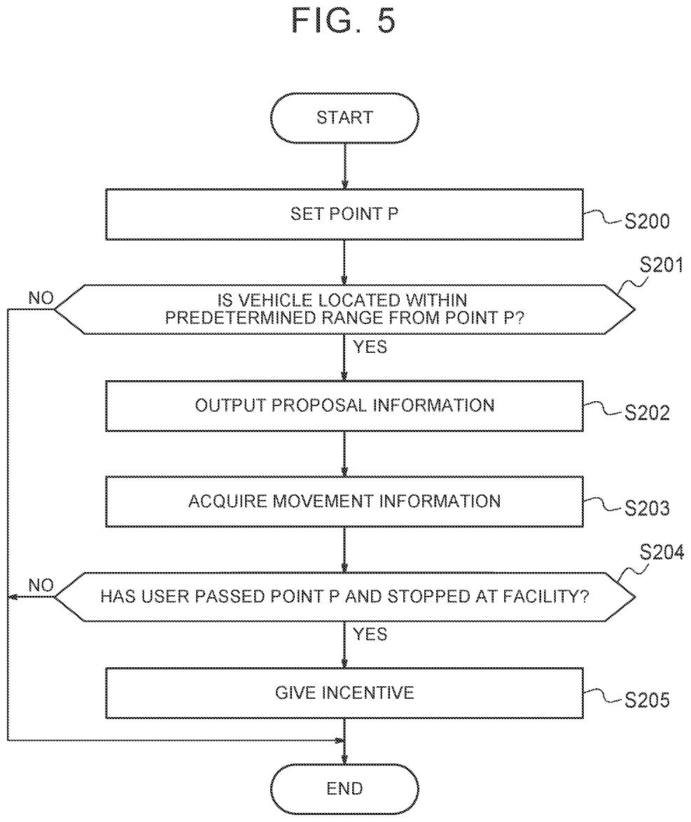

A second operation of the information processing device 20 according to the present embodiment will be described with reference to FIG. 5. The operation corresponds to a method according to the one embodiment of the present disclosure.

Step S200: The control unit 21 of the information processing device 20 sets a point P where traffic frequency becomes less than a predetermined threshold value. Step S200 is the same as step S100 described above.

Step S201: The control unit 21 of the information processing device 20 determines whether the vehicle 10 is located within a predetermined range from the point P. When the control unit 21 determines that the vehicle 10 is located within the predetermined range from the point P, the process proceeds to step S202. On the other hand, when the control unit 21 determines that the vehicle 10 is not located within the predetermined range from the point P, the process ends.

Here, a point different from step S101 described above will be specifically described. The positioning unit 36 of the terminal device 30 repeatedly measures the position of the terminal device 30 corresponding to the position of the vehicle 10. Then, the control unit 31 of the terminal device 30 transmits information indicating the position of the terminal device 30 to the information processing device 20 via the communication unit 32 every time the positioning unit 36 measures the position of the terminal device 30. Then, the control unit 21 of the information processing device 20 receives the information indicating the position of the terminal device 30 from the terminal device 30 via the communication unit 22. Then, the control unit 21 of the information processing device 20 determines whether the position of the terminal device 30 corresponding to the position of the vehicle 10 is within the predetermined range from the point P. The predetermined range from the point P may include, for example, a range within 500 m, a range within 400 m, a range within 300 m, a range within 200 m, or a range within 100 m from the point P, but is not limited to these.

Instead, the control unit 21 of the information processing device 20 may determine in step S201 based on the information indicating the position of the vehicle 10 acquired from the car navigation device mounted on the vehicle 10 via the communication unit 22.

Step S202: The control unit 21 of the information processing device 20 outputs proposal information for proposing to the user 50 that an incentive is given when the user 50 passes the point P in the vehicle 10 and stops at a facility located around the point P.

Here, a point different from step S102 described above will be specifically described. The control unit 21 of the information processing device 20 searches for a facility located around the point P based on the map information stored in advance in the storage unit 23. Then, the control unit 21 of the information processing device 20 outputs proposal information for proposing to the user 50 that an incentive is given when the user 50 passes the point P in the vehicle 10 and stops at the searched facility. Then, the control unit 21 of the information processing device 20 transmits the generated proposal information to the terminal device 30 via the communication unit 22. Then, the control unit 31 of the terminal device 30 receives the transmitted proposal information from the information processing device 20 via the communication unit 32. Then, the control unit 31 of the terminal device 30 outputs the received proposal information to the user 50 on a screen display or by voice and the like via the output unit 35. For example, the control unit 31 may output the proposal information to the user 50 by displaying the information indicating the point P and the searched facility on the map displayed on the screen of the terminal device 30 as well. As described above, the facility located around the point P is not the original destination of the user 50, but a place where the information processing device 20 encourages the user 50 who is moving in the vehicle 10 to a destination different from the facility to stop, for example. The range around the point P may include, for example, a range within 500 m, a range within 400 m, a range within 300 m, a range within 200 m, or a range within 100 m from the point P, but is not limited to these.

In step S202, the control unit 21 of the information processing device 20 may search for a movement route from the current position of the vehicle 10 to the searched facility via the point P based on the information indicating the current position of the terminal device 30 corresponding to the current position of the vehicle 10. Then, the control unit 21 of the information processing device 20 may add the information indicating the searched movement route to the proposal information. In this case, the control unit 31 of the terminal device 30 also outputs the information indicating the movement route received from the information processing device 20 to the user 50 on the screen display or by voice and the like via the output unit 35. One or more movement routes may be shown.

Step S203: The control unit 21 of the information processing device 20 acquires movement information of the user 50.

Here, a point different from step S103 described above will be specifically described. The positioning unit 36 of the terminal device 30 repeatedly measures the position of the terminal device 30 until the position of the terminal device 30 matches any position in the facility searched in step S202. Then, the control unit 31 of the terminal device 30 transmits information indicating the position of the terminal device 30 to the information processing device 20 via the communication unit 32 every time the positioning unit 36 measures the position of the terminal device 30. Then, the control unit 21 of the information processing device 20 receives the information indicating the position of the terminal device 30 from the terminal device 30 via the communication unit 22. Then, when the control unit 21 of the information processing device 20 determines that the position of the terminal device 30 matches any position in the facility searched in step S202, the control unit 21 acquires information indicating the movement route of the terminal device 30 corresponding to the movement information of the user 50 by analyzing transition of the position of the terminal device 30 in the past.

Step S204: The control unit 21 of the information processing device 20 determines whether the user 50 has passed the point P in the vehicle 10 and has stopped at the facility located around the point P based on the movement information of the user 50. When the control unit 21 determines that the user 50 has passed the point P in the vehicle 10 and has stopped at the facility located around the point P, the process proceeds to step S205. On the other hand, when the control unit 21 determines that the user 50 has passed the point P in the vehicle 10 but has not stopped at the facility located around the point P, the process ends. Step S204 is the same as step S104 described above.

Step S205: The control unit 21 of the information processing device 20 determines that an incentive is given to the user 50. Step S205 is the same as step S105 described above.

The control unit 21 of the information processing device 20 according to the present embodiment outputs proposal information for proposing to the user 50 of the vehicle 10 that an incentive is given when the user 50 has passed, in the vehicle 10, the point P where traffic frequency becomes less than the predetermined threshold value and has stopped at the predetermined facility. Then, the control unit 21 of the information processing device 20 determines that an incentive is given to the user 50 when the control unit 21 determines that the user 50 has passed the point P in the vehicle 10 and has stopped at the predetermined facility based on the movement information of the user 50.

According to such a configuration, the user 50 can obtain an incentive by stopping at a predetermined facility using, for example, a back road or a narrow street where traffic frequency is low. For this reason, it is possible to suppress the user 50 from stopping at a predetermined facility using, for example, a main road where traffic frequency is high. Therefore, it is possible to improve the technique for alleviating the traffic congestion. In addition to this, by alleviating the traffic congestion, land values will increase around the predetermined facility, which can contribute to the real estate industry.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

As a modification, an embodiment in which the configuration and operation of the information processing device 20 are distributed to a plurality of computers capable of communicating with each other is also possible. Furthermore, for example, an embodiment in which a part of or all of the components of the information processing device 20 are provided in the vehicle 10 is also possible. For example, the car navigation device mounted on the vehicle 10 may include a part of or all of the components of the information processing device 20.

Further, as a modification, the control unit 21 of the information processing device 20 may predict traffic frequency when the vehicle 10 passes the point P based on the past congestion information. Specifically, the control unit 21 of the information processing device 20 receives the past congestion information at the point P from a server or the like that provides congestion information via the communication unit 22. Then, the control unit 21 of the information processing device 20 learns the traffic frequency at the point P at an appropriate time from the past congestion information at the received point P by using any machine learning technique. Then, the control unit 21 of the information processing device 20 estimates the time when the vehicle 10 passes the point P based on the current position of the vehicle 10. Then, the control unit 21 of the information processing device 20 predicts the traffic frequency at the point P at the estimated time based on the traffic frequency at the learned point P at an appropriate time. Note that machine learning may include any machine learning using, for example, a support vector machine or a neural network, but is not limited to these.

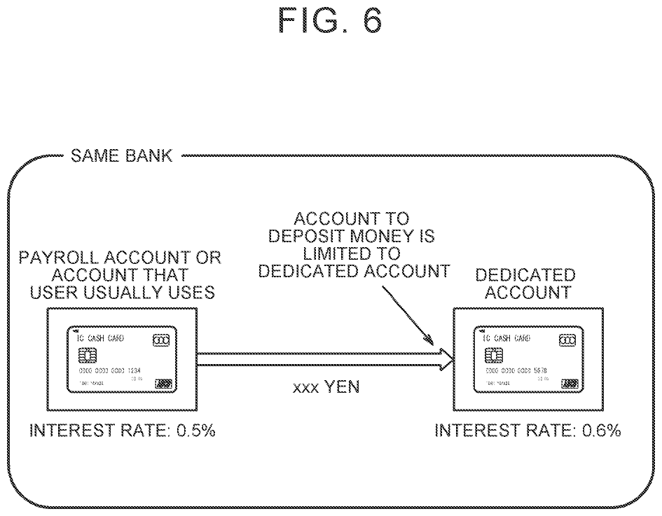

Further, as a modification, the incentive may include raising the interest rate of a deposit account or reducing the fee for investing in securities, etc. An example of giving an incentive to the user 50 by raising the interest rate of the deposit account will be described with reference to FIG. 6. In the example of FIG. 6, a preset amount is transferred from the bank account that the user 50 usually uses to a dedicated account with a higher interest rate than that of the bank account that the user 50 usually uses. However, it is an applicable condition that the balance of the bank account that the user 50 usually uses is equal to or more than the preset amount.

Further, as a modification, the information processing device 20 may directly output the proposal information to the user 50 instead of outputting the proposal information to the network 40. That is, the information processing device 20 may directly present the proposal information to the user 50 instead of transmitting the proposal information to the terminal device 30 and causing the user 50 to present the proposal information.

Further, as a modification, an embodiment in which a general-purpose computer functions as the information processing device 20 according to the above-described embodiment is also possible. Specifically, a program describing processing contents for realizing each function of the information processing device 20 according to the above-described embodiment is stored in the memory of the general-purpose computer, and the program is read out and executed by the processor. Alternatively, an embodiment in which a general-purpose mobile device functions as the terminal device 30 according to the above-described embodiment is also possible. Specifically, a program describing processing contents for realizing each function of the terminal device 30 according to the above-described embodiment is stored in the memory of the general-purpose mobile device, and the program is read out and executed by the processor. Therefore, the present disclosure according to the present embodiment can also be realized as a program that can be executed by the processor or a non-transitory computer-readable medium that stores the program.

What is claimed is:

1. An information processing device comprising a control unit that:
outputs proposal information for proposing to a user of a vehicle that an incentive is given when the user passes, in the vehicle, a point where traffic frequency becomes less than a predetermined threshold value and stops at a predetermined facility; and
determines that the incentive is given to the user when determination is made that the user has passed the point in the vehicle and has stopped at the predetermined facility based on movement information of the user.

2. The information processing device according to claim 1, wherein the proposal information further includes information indicating a movement route including a section from the point to the predetermined facility.

3. The information processing device according to claim 2, wherein the movement route does not include a road having a certain number of lanes or more or an intersection on the road.

4. The information processing device according to claim 1, wherein:
the predetermined facility is located at a destination set by the user; and
the control unit outputs the proposal information when determination is made that information indicating the destination has been received.

5. The information processing device according to claim 1, wherein:
the predetermined facility is located around the point; and
the control unit outputs the proposal information when determination is made that the vehicle is located within a predetermined range from the point.

6. The information processing device according to claim 1, wherein the control unit predicts the traffic frequency when the vehicle passes the point based on past congestion information.

7. The information processing device according to claim 1, wherein the control unit determines the incentive according to the number of times the user has acted in accordance with the proposal information.

8. A method executed by an information processing device, the method comprising:
outputting proposal information for proposing to a user of a vehicle that an incentive is given when the user passes, in the vehicle, a point where traffic frequency becomes less than a predetermined threshold value and stops at a predetermined facility; and
determining that the incentive is given to the user when determination is made that the user has passed the point in the vehicle and has stopped at the predetermined facility based on movement information of the user.

9. The method according to claim 8, wherein the proposal information further includes information indicating a movement route including a section from the point to the predetermined facility.

10. The method according to claim 9, wherein the movement route does not include a road having a certain number of lanes or more or an intersection on the road.

11. The method according to claim 8, wherein:
the predetermined facility is located at a destination set by the user; and
the method further includes outputting the proposal information when determination is made that information indicating the destination has been received.

12. The method according to claim 8, wherein:
the predetermined facility is located around the point; and
the method further includes outputting the proposal information when determination is made that the vehicle is located within a predetermined range from the point.

13. The method according to claim 8, further comprising predicting the traffic frequency when the vehicle passes the point based on past congestion information.

14. The method according to claim 8, further comprising determining the incentive according to the number of times the user has acted in accordance with the proposal information.

15. A program that causes a computer to execute:
outputting proposal information for proposing to a user of a vehicle that an incentive is given when the user passes, in the vehicle, a point where traffic frequency becomes less than a predetermined threshold value and stops at a predetermined facility; and
determining that the incentive is given to the user when determination is made that the user has passed the point in the vehicle and has stopped at the predetermined facility based on movement information of the user.

16. The program according to claim 15, wherein the proposal information further includes information indicating a movement route including a section from the point to the predetermined facility.

17. The program according to claim 16, wherein the movement route does not include a road having a certain number of lanes or more or an intersection on the road.

18. The program according to claim 15, wherein:
the predetermined facility is located at a destination set by the user; and
the program causes the computer to further execute outputting the proposal information when determination is made that information indicating the destination has been received.

19. The program according to claim 15, wherein:
the predetermined facility is located around the point; and
the program causes the computer to further execute outputting the proposal information when determination is made that the vehicle is located within a predetermined range from the point.

20. The program according to claim 15, the program causing the computer to further execute predicting the traffic frequency when the vehicle passes the point based on past congestion information.
